(19) United States
(12) Patent Application Publication
(10) Pub. No.: US 2009/0303831 A1
(43) Pub. Date: Dec. 10, 2009

(54) Application of Microdots and Other Identifiers to an Article

(75) Inventors: Ian Allen, New South Wales (AU); Geoff George, New South Wales (AU)

Correspondence Address: HARNESS, DICKEY & PIERCE, P.L.C., P.O. BOX 828, BLOOMFIELD HILLS, MI, 48303, US

(73) Assignee: DataDot Technology Ltd., Frenchs Forest (AU)

(21) Appl. No.: 12/095,994

(22) PCT Filed: Oct. 18, 2006
(86) PCT No.: PCT/AU06/01540

§ 371 Date: Sep. 22, 2008

(30) Foreign Application Priority Data
Dec. 6, 2005 (AU) 2005906856
Aug. 8, 2006 (AU) 2006904283

(51) Int. Cl. B05B 11/06

(52) U.S. Cl. 366/130

(57) ABSTRACT

A hand-held unit for applying identifying microdots mixed within an adhesive base fluid, comprises a housing which mounts a container for the mixture and a canister of propellant gas. When an outlet valve of the canister is depressed, propellant gas flows from the canister into a nozzle whereby mixture is drawn from the container for discharge through that nozzle for application of the mixture to an article, a vehicle for example, for identification purposes.

The present invention relates to the application of microdots and other identifiers to an article to provide identification of that article, for example in the event of theft.

The application of identifying microdots to a vehicle for identification purposes is known. A batch of microdots, typically 10,000 or more, encoded with identical identifying data discreet to that particular vehicle and each readable by the eye under magnification, is applied to the vehicle in a number of different places using a strong adhesive. In the event of theft, although an attempt may be made to remove identifying microdots, due to their very small size and large number, it is unlikely that all of the microdots will ever able to be removed so it is likely that there will always be some microdots remaining on different parts of the vehicle for subsequent identification.

A system has been developed for applying the microdot/adhesive mixture from a nozzle using pressurised air supplied by an air line leading from a compressor. While this system works effectively in many situations, the presence of the air line can impede access of the dispensing system to confined spaces. Moreover the need for an air line to power the system does restrict its possible range of applications and in particular precludes its use in domestic situations for example for marking valuable electronic equipment susceptible to theft.

The present invention provides a self-contained unit for dispensing a microdot/adhesive mixture and other identifier mixtures.

According to the present invention there is provided a hand-held unit for applying identifiers to an article, the unit comprising a container for containing a mixture of a base fluid with identifiers therein, a discharge nozzle having an internal chamber which communicates with the mixture in the container via a tube extending into the mixture, a canister of pressurised propellant gas, the canister having an outlet valve, and means defining a passage extending between an outlet of the canister and the internal chamber of the nozzle whereby when the outlet valve is opened propellant fluid flowing through the internal chamber draws the mixture through the tube and into the internal chamber for discharge through the nozzle.

The identifier mixture may consist of an adhesive base fluid with a multiplicity of identically coded identifying microdots mixed therein, typically several tens of thousands of such microdots. While the unit will be specifically designed for use with such a microdot mixture, nevertheless it is also suitable for use with other identifier mixtures, for example a mixture of DNA tracers within a suitable base fluid.

In a preferred embodiment of the invention, the unit includes a housing to which the pressure canister and container are fitted to lie one along side the other. The outlet valve of the canister is a spring-loaded valve which is opened by depressing a button mounted to a stem of the valve so as to be accessible for actuation by a digit of the hand while the unit is being held by the same hand. The discharge nozzle is mounted to the housing or, alternatively, to a removable closure of the container, and the passage extending between the outlet and the nozzle preferably comprises a flexible tube extending from the outlet of the canister.

In a particularly preferred form the canister is mounted to the housing so that it depends from the housing and the unit is held by gripping the body of the canister with the discharge button being accessible via an opening in an upper part of the housing for engagement by a digit of the hand. Preferably the housing engages with the canister by means of a snap-fastening with an upper rim of the canister in the zone of the discharge valve.

Preferably the propellant gas is discharged into the internal chamber of the discharge nozzle via a nozzle which lies adjacent to the discharge nozzle and defines a wall of the internal chamber.

Preferably the container for the mixture is also attached to the underside of the housing for example by a screw fitting and in the in-use position in which the canister is held by the hand of the user, the container is located forwardly of the canister.

Conveniently, the housing is formed as a one-piece plastics moulding whereby the housing can be produced relatively inexpensively so that the entire unit consisting of the housing, container, and propellant canister can be disposed of when the mixture has been discharged from the container. This means that the quantity of propellant within the canister is matched to the quantity of mixture within the container. As the unit is intended to be disposed of after discharge of the batch of mixture within the container, the unit does not need to be designed to avoid contamination between successive batches of mixture and which is necessary in a system designed for repeated use when each successive batch of mixture contains microdots or other identifiers which are discreet to that batch and therefore different from every other batch.

These and other aspects will now be further described by way of example only with reference to the accompanying drawings in which:

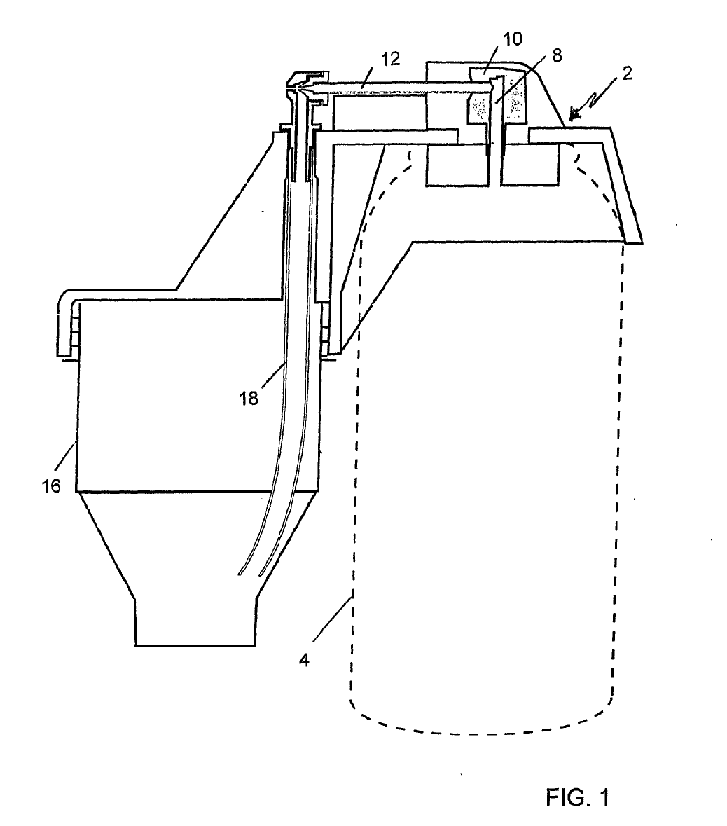

FIG. 1 is a schematic cross-section showing a unit in accordance with the preferred embodiment of the invention;

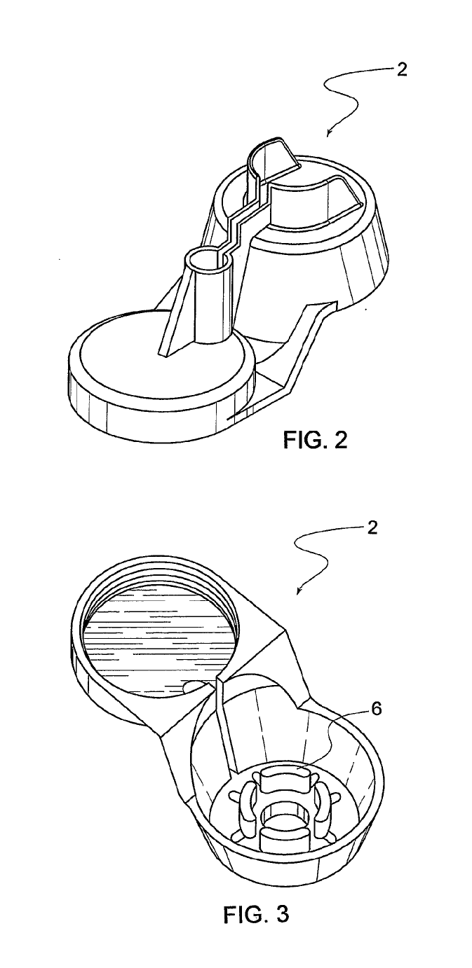

FIG. 2 is a perspective view showing a one-piece plastic housing of the unit;

FIG. 3 is an underneath view of the housing;

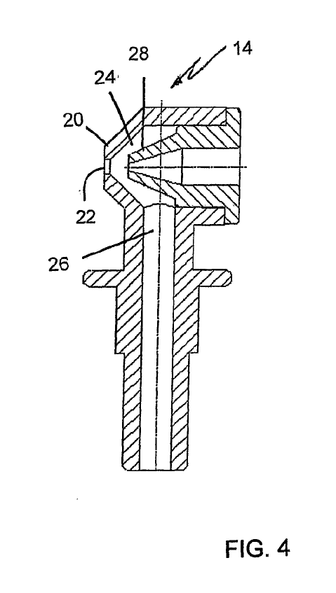

FIG. 4 is a cross-section through a discharge nozzle assembly of the unit; and

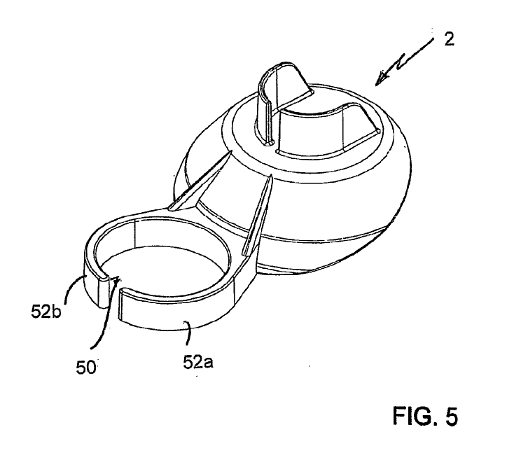

FIG. 5 is a perspective view of a modified form of the housing.

In the preferred embodiment of the invention the unit comprises a one-piece plastic housing which in the form shown is a cap 2 designed to be a snap-fit over the upper end portion of a canister 4 containing pressurised propellant gas. The snap-fit can be achieved by lugs 6 on the underside of the cap 2 and which lock into engagement within a rolled rim at the upper end of the canister in order to firmly secure the cap 2 to the canister. The canister includes a spring-loaded discharge valve 8 at its upper end to discharge the contents when the valve is opened by being depressed by the user. The canister is filled with a liquefied propellant gas and is basically a standard aerosol type container but differs from a standard aerosol container in that there is no dip tube extending from the valve into the liquid contents of the canister. Accordingly, when the valve is depressed, only propellant gas will be released. We have determined that a particularly suitable propellant gas for this purpose is LPG. The upper end of the valve stem through which propellant gas is discharged is housed within a button 10 which is accessible from the top of the cap 2. The button 10 also mounts a flexible discharge tube 12 which communicates with the valve stem to direct propellant gas to a discharge nozzle assembly 14 when the button 10 is depressed to open the valve.

The cap 2 also carries a container 16 for a mixture of adhesive and identically coded microdots. By way of example, the container 16 may carry in excess of 10,000 microdots identically coded. The container 16 is applied to the underside of the cap 2, for example by a screw fitting, so that it is suspended from the cap 2 and extends alongside, and substantially parallel to, the pressure canister 4. The upper part of the cap 2 carries the discharge nozzle assembly 14 which lies above the container 16 and which is linked to the interior of the container 16 by a draw tube 18, the lower end of which is immersed within the mixture within the container.

The discharge nozzle assembly 14 is illustrated in greater detail in FIG. 5 and comprises a discharge nozzle 20 having a discharge orifice 22 leading from an internal chamber 24. A feed passage 26 to which the upper end of the draw tube 18 is connected, leads into that chamber. A propellant gas discharge nozzle 28 to which the discharge end of the flexible tube 12 is connected, also leads into the chamber 24 and it will be seen that the nozzle 28 is in close proximity to the discharge orifice 22 of the discharge nozzle 20.

When propellant gas is discharged under pressure through the nozzle 28 when the button 10 is depressed, the propellant gas flowing at high velocity through the chamber 24 will generate a pressure drop within the chamber 24 whereby the microdot/adhesive mixture will be drawn through the tube 18 into the chamber 24 for discharge in spray form through the discharge orifice 22.

It has been determined that the spacing between the nozzle 28 and the discharge orifice 22 is quite critical. If the nozzle 28 is spaced too far to the rear of the discharge orifice 22 there tends to a pressure build-up within the internal chamber of the discharge nozzle and this overrides the suction effect created by the rapidly moving propellant gas. On the other hand, the nozzle 28 must be spaced behind the discharge orifice by a sufficient distance to define a passage through which the microdot/adhesive mixture can flow without the microdots blocking that passage. Whereas in prior systems for dispensing microdots using an air line, microdots of a diameter of up to approximately 1 mm are able to be used, with the present unit we have determined that if the size of the microdots is limited to approximately 0.5 mm the functional requirements for the spacing between the propellant gas discharge nozzle 28 and discharge orifice 22 can be achieved without blockage by the microdots. The actual spacing for optimum results will be determined empirically. It has been determined that for a microdot size of no more than 0.5 mm diameter, a discharge orifice of a diameter of approximately 1 mm will provide a confined spray of the mixture which can be accurately targeted. It will be understood that even microdots of a diameter of 0.5 mm or slightly less are still able to be read by the human eye under optical magnification without requiring the use of specialised magnifying equipment.

In use, the unit is held in the hand of the user, with the hand gripping the pressurised canister 4 and a finger of the hand actuating the push button 10 to open the valve to effect dispensing of the microdot/adhesive mixture.

As the unit is self-contained with supply of the propellant gas provided by the pressurised canister, it is able to access confined spaces which might not be easily accessible to a system powered by an air line leading from a remote compressed air supply. Moreover it can be used in situations, for example domestic situations, where there is no ready access to a compressed air supply.

It is envisaged that in practice the contents of the pressurised canister will be sufficient only to discharge the contents of the single container 16 whereon the propellant gas will be substantially depleted so that the entire unit can be disposed of.

In a modification, the container 16 includes a removable closure which carries the discharge nozzle assembly 14. The cap 2 has, forwardly of the rear part to which the canister 4 is fitted, a generally cylindrical mounting 50 (see FIG. 5) into which the body of the container can be fitted, the body being provided at its upper end portion with an annular flange which sits on the mounting 50. Preferably the mounting is formed by two flexible arms 52a, 52b which frictionally grip the body of the container 16 to prevent its accidental removal during use; the flexibility of the arms 52a, 52b also permits the use in the unit of a range of containers 16 of differing diameters.

Although the system has utility for applying identifying microdots to vehicles of various types, it can used for marking a range of articles, such as electronic equipment as may be found in many households.

Although the unit is specifically designed for the dispensing of the microdot/adhesive mixture, it will be understood that the unit can dispense without modification other fluid mixtures which include identifiers, for example a DNA tracer, which act as identification labels to an article to which the mixture is applied.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

The embodiment has been described by way of example only and modifications are possible within the scope of the invention.

1. A hand-held unit for applying identifiers to an article, the unit comprising a container for containing a mixture of a base fluid with identifiers therein, a discharge nozzle having an internal chamber which communicates with the mixture in the container via a tube extending into the mixture, a canister of pressurized propellant gas, the canister having an outlet valve, and means defining a passage extending between an outlet of the canister and the internal chamber of the nozzle whereby when the outlet valve is opened propellant fluid flowing through the internal chamber draws the mixture through the tube and into the internal chamber for discharge through the nozzle.

2. A unit according to claim 1, wherein the identifier mixture consists of an adhesive base fluid with a multiplicity of identically coded identifying microdots mixed therein.

3. A unit according to claim 1, wherein the unit includes a housing to which the pressure canister and container are fitted to lie one along side the other, and the outlet valve of the canister is a spring-loaded valve which is opened by depressing a button mounted to a stem of the valve so as to be accessible in the housing for actuation by a digit of the hand while the unit is being held by the same hand.

4. A unit according to claim 3, wherein the passage extending between the outlet of the canister and the nozzle comprises a flexible tube extending from the outlet which is formed within the button.

5. A unit according to claim 3, wherein the canister is mounted to an underside of the housing so that it depends from the housing, and the unit is held by gripping the body of the canister with the discharge button being accessible via an opening in an upper part of the housing for engagement by a digit of the hand.

6. A unit according to claim 5, wherein the housing engages with the canister by means of a snap-fastening with an upper rim of the canister in the zone of the outlet valve.

7. A unit according to claim 5, wherein the container is carried by the housing in such a configuration that, in the in-use position in which the canister is held by the hand of the user, the container is located forwardly of the canister.

8. A unit according to claim 5, wherein the discharge nozzle is mounted to the housing, and the container is releasably attached to the housing so as to extend downwardly therefrom.

9. A unit according to any claim 5, wherein the discharge nozzle is mounted to a removable closure of the container, and the container with closure is removably mounted to the housing.

10. A unit according to claim 5, wherein the passage extending between the outlet of the canister and the nozzle comprises a flexible tube extending from the outlet which is formed within the button.
